(19) United States
(12) Patent Application Publication
(10) Pub. No.: US 2005/0117861 A1
(43) Pub. Date: Jun. 2, 2005

(54) Structure of a diffusing film and prism film in LCD screen

(76) Inventor: Jung-Yen Hsu, Xin-Ying City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/724,758

(22) Filed: Dec. 2, 2003

(51) Int. Cl. G02B 6/08

(52) U.S. Cl. 385/120

(57) ABSTRACT

An improved structure of a diffusing film and prism film in LCD screen mainly relates to using general optical fiber array to substitute for the structure of a diffusing film and prism film. This general optical fiber array is combined with the plural of short general optical fibers to be slices in an identical direction. In addition, the substitutes also can be the optical micro-fiber arrays formed by optical micro-fibers.

### BACKGROUND OF THE INVENTION

1. Field of the Invention

The present invention relates to an improved structure of a diffusing film and prism film in LCD screen. Particularly, it relates to using one optical fiber array to substitute for a diffusing film and a prism film in LCD (LIQUID CRYSTAL DISPLAY LCD) for changing the direction of light progress and then controlling it to use.

2. Prior Art

As showing in FIG. 1, the structures of LCD screen (A) using habitually are rear light module composed of lead-light panel (B), diffusing film (C) and prism film (BEF) (D) which are parts of optical elements. Further, the rear light module of said optical elements will be combined with TFT Cell (F) and TFT Panel (G) to be a whole LCD screen (A); within the prism film can be one or two. Although this kind of structure of LCD screen still conforms to practical use, the quality of displayed film is not exquisite enough.

### OBJECTS OF THE INVENTION

The primary purpose of the present invention is constantly improving the displayed film on the LCD screen to be more exquisite and clear; besides, providing an improved structure of a diffusing film and a prism film in LCD screen. The method is using general optical fiber array to substitute for a diffusing film and prism film in LCD screen and to achieve functions of changing the direction of light progress and then controlling it to use.

The second purpose of the present invention is using optical micro-fiber array to substitute for a diffusing film and prism film within the rear light module in order to make the quality of displayed film more ideal.

### BRIEF DESCRIPTION OF THE DRAWING

FIG. 1 a perspective view of the structure of LCD screens using habitually.

FIG. 2 and FIG. 3 are enlarged perspective views of the structure of general optical fiber array of the present invention.

FIG. 4 is an enlarged perspective view of lights in the general optical fiber by way of total reflection to transfer rays.

FIG. 5 is an enlarged perspective view of the plural of optic micro-fibers in the general optical fiber.

### DESCRIPTION OF THE PREFERRED EMBODIMENT

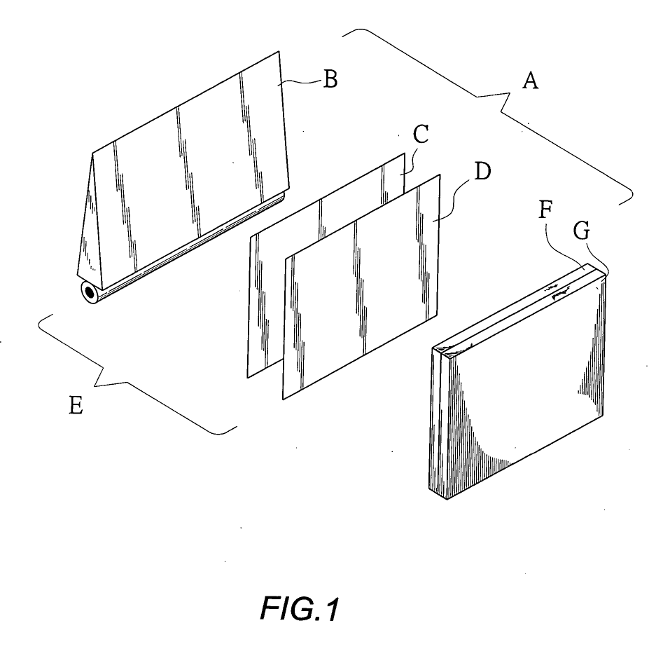

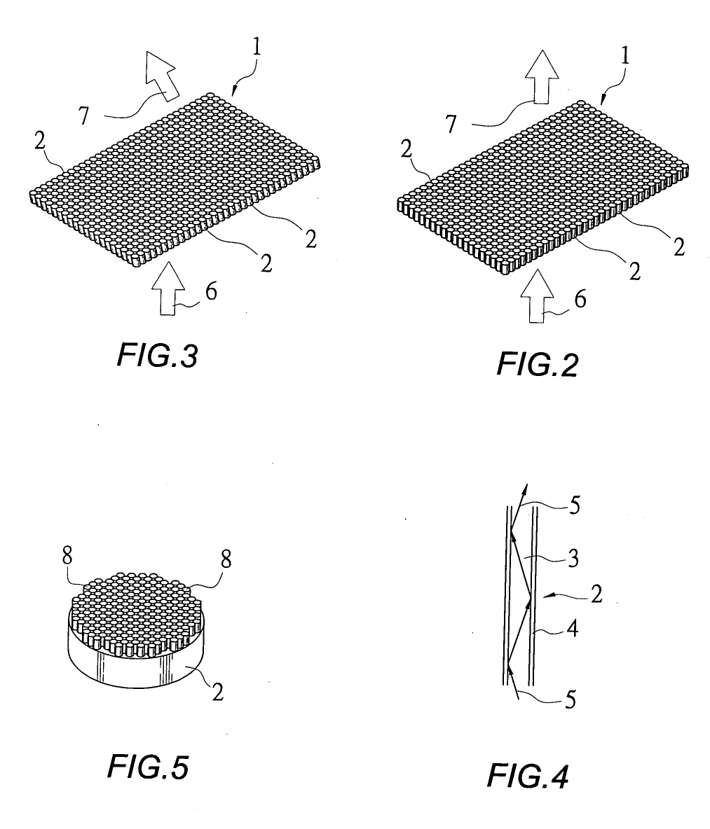

As showing in FIGS. 1, 2, 3 and 4, the present invention is using general optical fiber array (1) to substitute for the structure of a diffusing film (C) and prism film (D) using habitually. This general optical fiber array (1) is combined with the plural of short general optical fibers (2) to be slices in an identical direction. Within every general optical fiber (2) uses the light principle of total reflection to transfer rays. As showing in FIG. 4, one general optical fiber (2) is divided into two parts of the interior (3) and exterior (4); the refractive index of internal (3) materials is about 1.8 and the refractive index of external materials is about 1.4. Because the incident angle is bigger than the critical angle, light can be transferred from a point of one general optical fiber (2) as showing of the arrow (5) directs owing to total reflection. The diameter of every general optical fiber (2) is very thin, and it is only about microns; therefore, lights (6) shooting into the lead-light panel (B) can be separated and become thinner lights (7) shooting out via points of plural of general optical fibers (2) to make the quality of film on LCD screen (G) more exquisite and clear.

As showing in FIG. 5, plural of optical micro-fibers (8) are in one general optical fiber (2) made into the optical micro-fiber array and the effect is superior to the effect of the general optical fiber (2).

1. An improved structure of a diffusing film and prism film in LCD screen mainly relates to using general optical fiber array to substitute for the structure of a diffusing film and prism film in LCD screen; said general optical fiber array is combined with the plural of short general optical fibers to be slices in an identical direction.

2. An improved structure of a diffusing film and prism film in LCD screen according to claim 1, wherein the general optical fiber array is substituted by one optical micro-fiber array.
